(19) United States
(12) Patent Application Publication
(10) Pub. No.: US 2008/0289471 A1
(43) Pub. Date: Nov. 27, 2008

(54) Sheet Transport and Reorientation Assembly for a Punch

(75) Inventors: Frank Todaro, Old Saybrook, CT (US); Peter Hotkowski, Chester, CT (US); James T. Russo, Chicago Heights, IL (US); Thomas T. Battisti, Buffalo Grove, IL (US)

Correspondence Address: MICHAEL BEST & FRIEDRICH LLP, 100 EAST WISCONSIN AVENUE, SUITE 3300, MILWAUKEE, WI, 53202, US

(73) Assignee: GENERAL BINDING CORPORATION, Northbrook, IL (US)

(21) Appl. No.: 12/063,833

(22) PCT Filed: Aug. 4, 2006
(86) PCT No.: PCT/US2006/030542

§ 371 Date: Jul. 15, 2008

Related U.S. Application Data
(60) Provisional application No. 60/708,616, filed on Aug. 16, 2005.
(60) Provisional application No. 60/709,708, filed on Aug. 18, 2005.

(51) Int. Cl. B21D 28/34; B26D 5/08; B26D 3/00

(52) U.S. Cl. 83/699.31; 83/618; 83/50

(57) ABSTRACT

A punch assembly for punching a plurality of consecutive sheets each having a first edge and a second edge generally opposite the first edge includes a punch and a transport assembly having a feeding path for feeding the first edge of a sheet in a feeding direction relative to the punch for punching thereof, and a removal path different from the feeding path for removing the sheet from the punch in a removal direction generally opposite to the feeding direction relative to the punch such that the second edge becomes a leading edge.

### RELATED APPLICATIONS

This application claims priority to U.S. Provisional Patent Application Ser. No. 60/708,616 filed on Aug. 16, 2005 and U.S. Provisional Patent Application Ser. No. 60/709,708 filed on Aug. 18, 2005, both of which are incorporated herein by reference.

### FIELD OF THE INVENTION

The invention relates generally to a punch for sheet material such as paper, and more particularly to a punch with a sheet feeding and reorientation mechanism that is capable of handling sheets fed to the punch at a high rate.

### BACKGROUND OF THE INVENTION

Commercial document processing machines, such as copiers or printers, often include a punch for punching holes in the printed sheets so that the sheets can be bound together. After a sheet is printed, it is transported to the punch for hole punching, and is then transported to the next processing stage, where the punched sheets may be accumulated into a stack for binding. Ideally, the punching operation should process the sheets at a rate that does not slow down the overall flow of documents through the document processing system. Due to the relatively high speed at which the printed sheets are generated by a commercial document processing machine, the transport mechanism for feeding sheets to the punch and removing them after they are punched must be capable of efficiently handling the flow of sheets in an efficient way.

Existing commercial document processing machines generally employ either of two approaches to transporting sheets in and out of the punch. The first approach uses a pass-through die set, and the second uses a rotary die set. The pass-through die set approach requires that each sheet be conveyed into a die set of the punch, stopped, punched, and then conveyed through the die set. These actions must take place before the following sheet arrives so that the lead edge of the following sheet will not collide with the trailing edge of the sheet being punched. In the arrangement disclosed in PCT Publication WO03/072474A3 upon which is based U.S. Publication 05-0039585A1, both assigned to the assignee of this application, the sheet leaving the copier or printer is accelerated to provide a gap between sheets coming into the punch to avoid crashes between the sheets. This arrangement additionally requires an active stop/start mechanism for each sheet.

In a rotary die set, the sheet is punched as it is moving, and an electronic trigger is used to control the phase of the punch operation. The rotary die set typically has two driver shafts coupled by gears. Punching pins are affixed to one shaft, and matching dies are formed on the other shaft. A sheet to be punched is passed through a nip between the two rotating shafts. While this approach does not require sheet acceleration, the synchronization of the driven shafts results in certain mechanical complexities that introduce opportunities for error. To get cleanly cut holes, the tolerances between the components on the two shafts have to be maintained to a high precision, such as within one-thousandth of an inch. Moreover, registration of the sheet in the direction of paper movement is not optimal. This approach may be fairly cost-effective for light-weight paper with simple hole patterns, such as three round holes per sheet. When the paper weight increases or when the punch pattern becomes more complicated (e.g., many rectangular holes), however, the components of the rotary die set can become expensive.

### SUMMARY OF THE INVENTION

In view of the foregoing, the present invention provides a punch with a sheet transport mechanism that is capable of handling a high sheet feed rate and providing precise registration of a sheet for hole punching without the need to use a complicated active setup to precisely control the movement and location of the sheet to be punched. The present invention also provides a sheet transport mechanism that may be disposed in a relatively small space in a document handling machine or system.

The present invention also provides a sheet transport mechanism for a punch that is mechanically simple and does not require complicated control or moving parts.

The present invention further provides a transport mechanism having a sheet feeding path for transporting a sheet to be punched in a feeding direction into the punch, and a sheet removal path for transporting the punched sheet out of the punch in a removal direction that is generally opposite to the feeding direction. A first sheet to be punched is fed along the sheet feeding path such that the originally leading edge of the sheet enters the punch and assumes a registered position. While the sheet is being punched, the originally trailing edge of the sheet is deflected onto the removal path, and becomes the leading edge as the punched sheet is carried out of the punch and transported to the next processing stage. The second sheet may be advanced toward the punch by the transport assembly once the originally trailing edge of the first sheet is deflected onto the removal path. In this way, the second sheet is advanced toward the punch as the first sheet is being punched, and the leading edge of the second sheet may enter the punch immediately after the originally leading edge (now the trailing edge in the removal direction) of the first sheet exits the punch.

The flow reversal may be provided by any appropriate arrangement. In a first such arrangement, a vacuum conveyor advances the sheet into the punch. Once registered, a deflector deflects the sheet to an output path, causing the originally trailing edge to become the leading edge. The deflector may be in the form of, for example, one or more mechanical fingers, an air jet, or a discontinuation of the vacuum.

In another arrangement, the deflector may comprise a curved rotating surface disposed such that the originally leading edge of the sheet is carried by the rotating surface through an input nip and advanced to a registered position in the punch. While the originally leading edge of the sheet remains registered in the punch, the originally trailing edge of the sheet is carried by the rotating surface through an exit nip and becomes the leading edge along a sheet removal path.

Thus, the combination of punching and sheet reversal provides a positive registration of the sheet for punching without slowing the flow of the sheet through the punch or without accelerating or decelerating the sheets from the printer. A sheet reversal or reorientation arrangement without a punch may likewise be used to provide a change in the sheet flow direction in a sheet processing system.

Other features and aspects of the invention will become apparent by consideration of the following detailed description and accompanying drawings.

### BRIEF DESCRIPTION OF THE DRAWINGS

FIG. 1 is a schematic diagram illustrating the general operational principle of a punch with a sheet transport assembly in accordance with the present invention.

FIG. 2a is a perspective view of a punch that may be used in an embodiment of the transport assembly of FIG. 1, illustrating multiple punch pins.

FIG. 2b is a cross-sectional view of a portion of the punch of FIG. 2a through line 2b-2b in FIG. 2a, illustrating the cross-sectional shape of one of the punch pins.

FIG. 2c is a cross-sectional view of an alternative construction of one of the punch pins in the punch of FIG. 2a.

FIG. 3a is a perspective view of one embodiment of the sheet transport assembly of FIG. 1, including vacuum-assisted entry and exit conveyers for transporting sheets to and from the punch.

FIG. 3b is a bottom perspective view of the entry conveyor of FIG. 3a, illustrating alternate means for providing vacuum suction to the entry conveyor.

FIG. 3c is a top perspective view of the exit conveyor of FIG. 3a, illustrating alternate means for providing vacuum suction to the exit conveyor.

FIG. 4a is a plan view of the exit conveyor utilized in the sheet transport assembly of FIG. 3a for removing sheets from the punch.

FIG. 4b is a plan view of the exit conveyor of FIG. 3c for removing sheets from the punch.

FIG. 5 is a cross-sectional view, with portions removed for clarity, of the transport assembly of FIG. 3a at one point of operation when a sheet is fed to the punch.

FIG. 6 is an enlarged cross-sectional view, with portions removed for clarity, of the transport assembly of FIG. 3a at another point of operation when the sheet is deflected to a removal path.

FIG. 7 is a top perspective view, with portions removed for clarity, of another embodiment of a sheet transport assembly including a rotating surface for deflecting a sheet from a feeding path to a removal path.

FIG. 8 is a side view of the transport assembly of FIG. 7 at one point of operation when a sheet is fed to the punch.

FIG. 9 is a side view of the transport assembly of FIG. 7 at another point of operation when a second edge of the sheet is carried by the driven roller from an input nip to an exit nip.

FIG. 10 is a side view of the transport assembly of FIG. 7 at another point of operation when the sheet is deflected to a removal path.

FIG. 11 is a perspective view, with portions removed for clarity, of another embodiment of an entry conveyor.

FIG. 12 is a reverse perspective view of the entry conveyor of FIG. 11, illustrating structure for adjusting movable edge guides that engage respective edges of the sheets being fed to the punch.

FIG. 13 is a reverse perspective view of the entry conveyor of FIG. 11, illustrating structure for deflecting sheets from the entry conveyor to the exit conveyor.

FIG. 14 is a perspective view, with portions removed for clarity, of yet another embodiment of an entry conveyor.

FIG. 15 is a reverse perspective view of the entry conveyor of FIG. 14, illustrating solenoids for actuating movable edge guides that engage respective edges of the sheets being fed to the punch.

FIG. 16 is a reverse perspective view of the entry conveyor of FIG. 14, illustrating structure for deflecting sheets from the entry conveyor to the exit conveyor.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

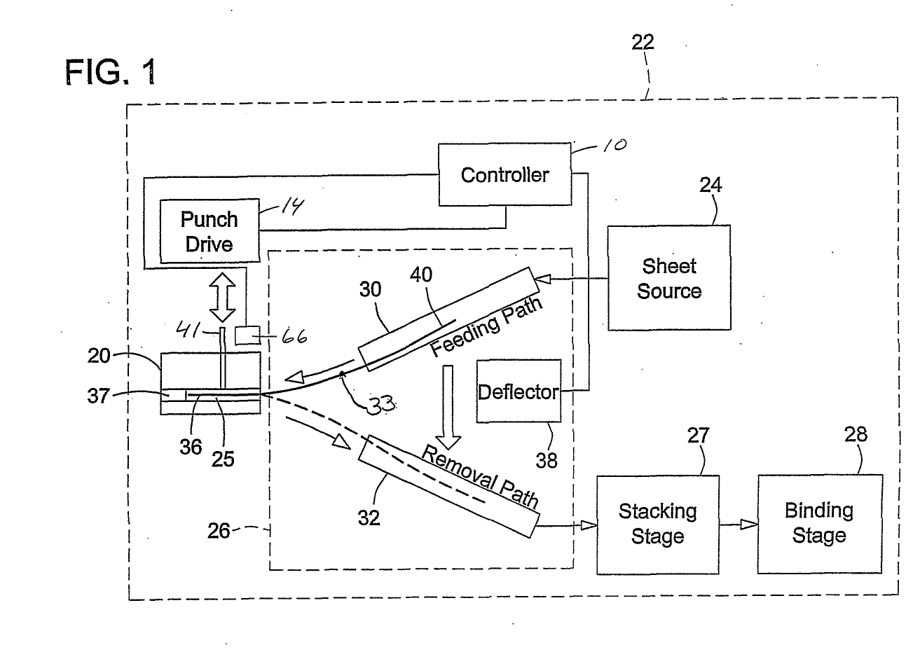

Referring to FIG. 1, the present invention is directed to a sheet transport mechanism for a punch 20 that is capable of handling a relatively high sheet feed rate. The punch may be a stand-alone unit, one component in a document-processing machine 22, such as a printer or copier, or a component of a larger sheet processing system. The document processing machine 22 includes a sheet source 24, such as a printing or copying component, that generates a stream of sheets. The sheets are transported consecutively by a transport assembly 26 to the punch 20, which punches holes of a desired pattern in each sheet to allow the punched sheets to be bound together. The punched sheets are then consecutively transported away by the transport assembly 26 from the punch 20 to the next processing stage, which for instance may be a stacking stage 27 where the punched sheets are stacked together to facilitate binding. The machine 22 may include a binding stage 28 that binds the punched and stacked sheets using a binding element of a selected type. One example of such a document processing machine 22 is shown and described in International application Ser. No. ______ filed Aug. 4, 2006, the entire contents of which is incorporated herein by reference. The document processing machine 22 shown and described in International application Ser. No. ______ may utilize binding elements shown and described in U.S. patent application Ser. No. ______ filed Aug. 4, 2006, the entire contents of which is incorporated herein by reference, to bind stacks of perforated or punched sheets.

As illustrated in FIG. 1, the transport assembly 26 includes a sheet feeding path 30 for feeding a sheet 33 from the sheet source 24 to the punch 20, and a sheet removal path 32 for removing the sheet from the punch 20 after it is punched and transporting it to the next processing stage. The transport assembly 26 for the punch 20 is configured such that it can feed sheets to the punch 20 for punching and remove the punched sheets out of the punch 20 at a high rate, while allowing each sheet to be precisely registered in the punch 20 for punching. A sheet 33 to be punched is advanced along the feeding path 30 until its first edge 36, which is the originally lead edge in the sheet feeding direction, is in registration for punching. The punch 20 is then activated to punch the sheet. The punched sheet is then moved along the sheet removal path 32 out of the punch.

In accordance with a feature of the invention, the sheet feeding direction along the sheet feeding path 30 is generally opposite to the sheet removal direction along the sheet removal path 32 in so far as it relates to the throat 25 of the punch 20. In other words, the travel direction of the sheet 33 is reversed after it is punched, such that the originally leading edge 36 becomes the trailing edge. In accordance with another feature of the invention, once the originally leading edge 36 of the sheet 33 is put in registration in the punch 20, a deflector mechanism 38 moves a second edge 40 of the sheet, which is the originally trailing edge along the feeding path 30, onto the sheet removal path 32 such that the originally trailing edge 40 of the sheet 33 becomes the leading edge as the punched sheet is removed from the punch and advanced along the sheet removal path 32. While the sheet feeding path 30 and removal path 32 are illustrated as feeding a sheet from a relative upper position and removing the sheet from a relative lower position, it will be appreciated by those of skill in the art that the sheet may be fed from a relative lower position and removed from a relative upper position in various embodiments of the invention. Similarly, it will be appreciated that the punch 20 may be disposed at an angle other than the horizontal position illustrated, and the sheet fed and removed from any appropriate direction so long as the punched sheet is removed from the throat 25 of the punch 20 in a direction generally opposite to the feeding direction into the punch.

A significant advantage of the sheet transport assembly 26 for the punch according to the invention is its ability to feed sheets consecutively to the punch 20 for punching at a relatively high rate. Once the second edge 40 of the sheet being punched is deflected onto the removal path 32, it will not interfere with the lead edge of a following sheet. This allows the following sheet to continue to be transported to the punch 20 while the first sheet is still being punched, such that there is no need to decelerate the following sheet to avoid a collision of its lead edge with the trailing edge of the first sheet. Another significant advantage is that the mechanical structure of the transport assembly 26 can be very simple and effective, without the need for sophisticated mechanism for controlling the speed and location of the sheets to be punched.

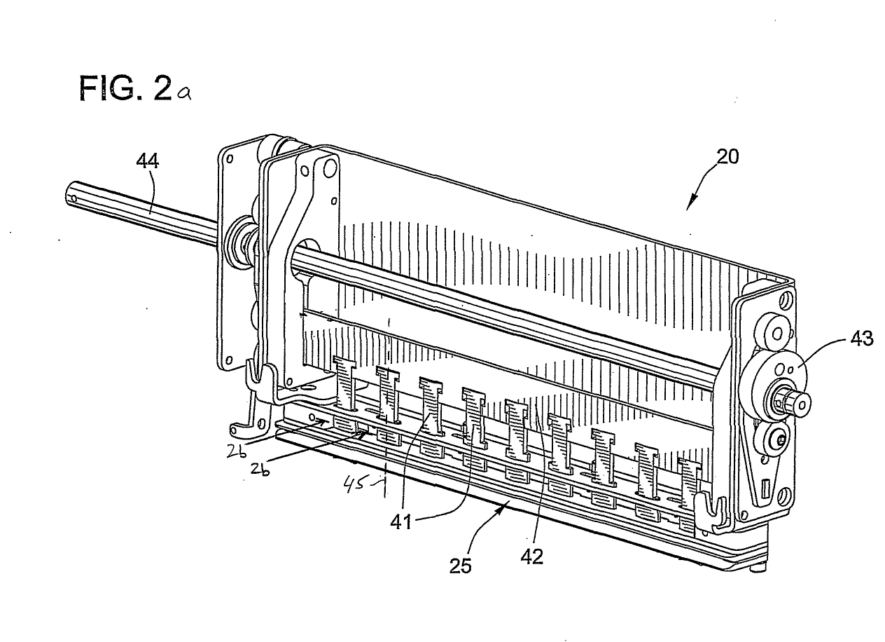

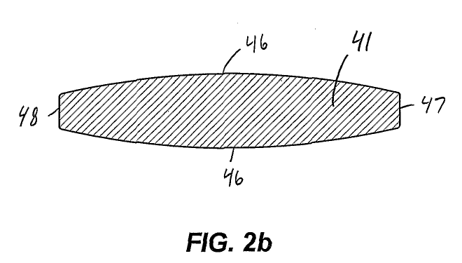

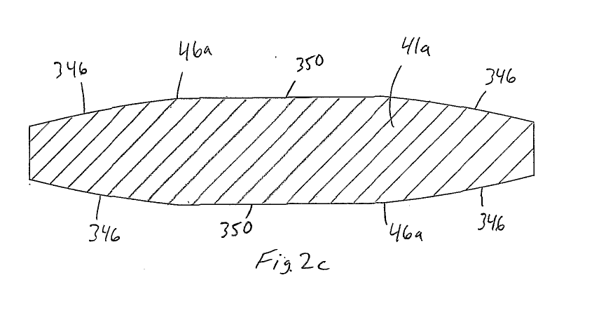

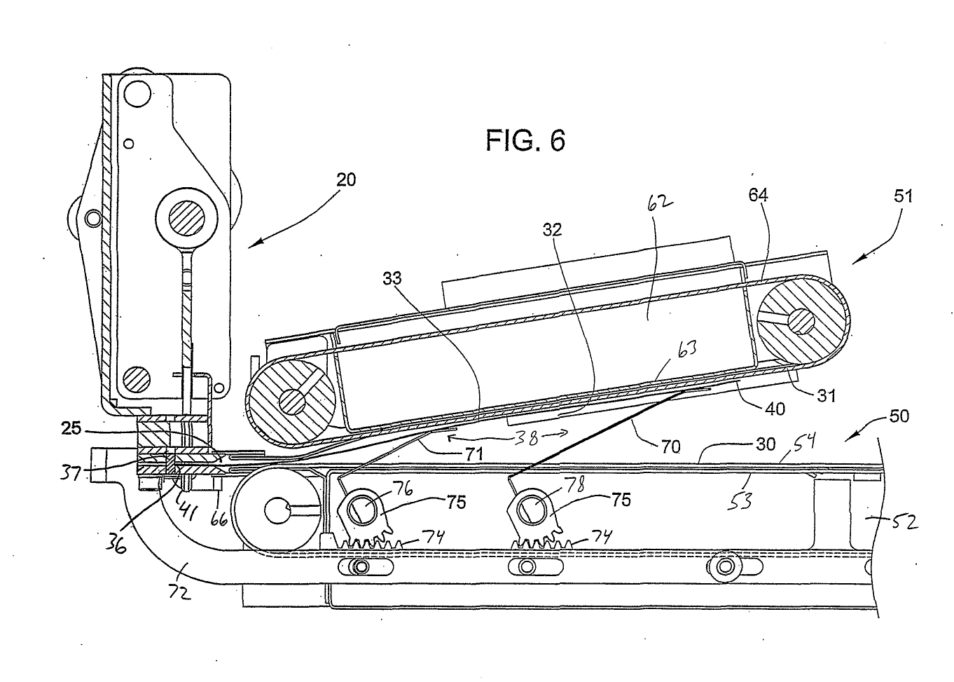

FIG. 2a illustrates a punch 20 that may be used for punching holes in sheets consecutively fed to it. The punch 20 utilized in the transport assembly 26 includes a throat 25 that receives the sheet to be punched and a back gauge or stop 37 (see FIGS. 1 and 6) for arresting the forward movement of the sheet entering the throat 25. In as much as the punched sheet exits the punch 20 back toward the direction from which it enters (i.e., the punched sheet does not pass through the punch 20), the structure for arresting forward movement may be static, secured to the punch 20, rather than movable to allow the punched sheet to pass completely through the punch 20.

The particular punch 20 illustrated in FIG. 2a is designed to punch an array of holes or perforations along an edge of a sheet, and has a plurality of punch pins 41 coupled to a connection bar 42. Each of the punch pins 41 defines a punching axis 45 along which the punch pins 41 are movable. The connection bar 42 is mounted such that it reciprocates up and down to move the punch pins 41 between a first position, in which the punch pins 41 are substantially outside of the throat 25, and a second position, in which the punch pins 41 are within the throat 25 or extend through the throat 25. The bar 42 is drivably coupled to a drive mechanism 14 (see FIG. 1) to impart the reciprocating motion of the bar 42 and punch pins 41. In the illustrated construction of the punch 20 in FIG. 2a, the drive mechanism 14 includes a drive device (e.g., a motor), an actuation shaft 44 connected to the motor, and cams 43 driven by the rotation of the actuation shaft 44. When the motor is energized, the motor rotates the shaft 44 to cause the cams 43 to press down the connection bar 42, causing the punch pins 41 to move down and punch holes or perforations along the edge of a sheet inserted into the throat 25 of the punch 20. It should be appreciated by those skilled in the art, however, the punch may be of any appropriate design that includes structure for arresting the forward movement of the sheet with the punch and may punch any appropriate size, shape, distribution or number of holes.

With reference to FIG. 2b, a cross-sectional shape of one of the punch pins 41 is shown, with the cross-section taken in a plane substantially perpendicular to the punching axis 45 of the punch pin 41 and passing through the punch pin 41. The cross-sectional shape of the punch pins 41 has opposed, at least partially arcuate longitudinal edges 46 and substantially parallel edges 47, 48 connecting the opposed arcuate longitudinal edges 46, generally forming what can be referred to as a “double-D” shaped cross-sectional shape of the punch pins 41. The double-D cross-sectional shape of the punch pins 41 creates perforations of substantially the same size and shape in the sheets received in the punch 20. The double-D cross-sectional shape of the punch pins 41 facilitates stacking of the perforated sheets during the stacking stage 27 (see FIG. 1) and alignment of the perforations in the individual sheets in the stack. As shown in FIG. 2b, substantially the entire length of the longitudinal edges 46 is arcuate. FIG. 2c illustrates an alternative construction of the punch pins 41a having the double-D cross-sectional shape, including longitudinal edges 46a having both arcuate portions 346 and substantially straight portions 350. As illustrated in FIG. 2c, the substantially straight portions 350 are located intermediate the arcuate portions 346 on each of the longitudinal edges 46a. As a result of the double-D shape of the perforations, individual sheets, as they are being stacked and aligned, are less likely to become caught or hung up in the perforations of an underlying sheet. In other embodiments, other cross-sectional shapes can be used for the punch pins 41.

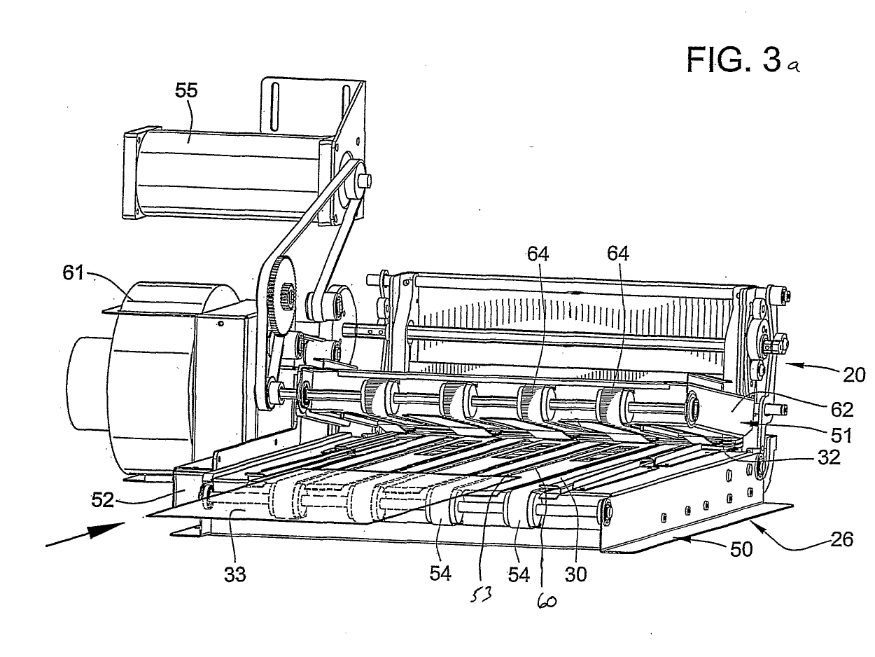

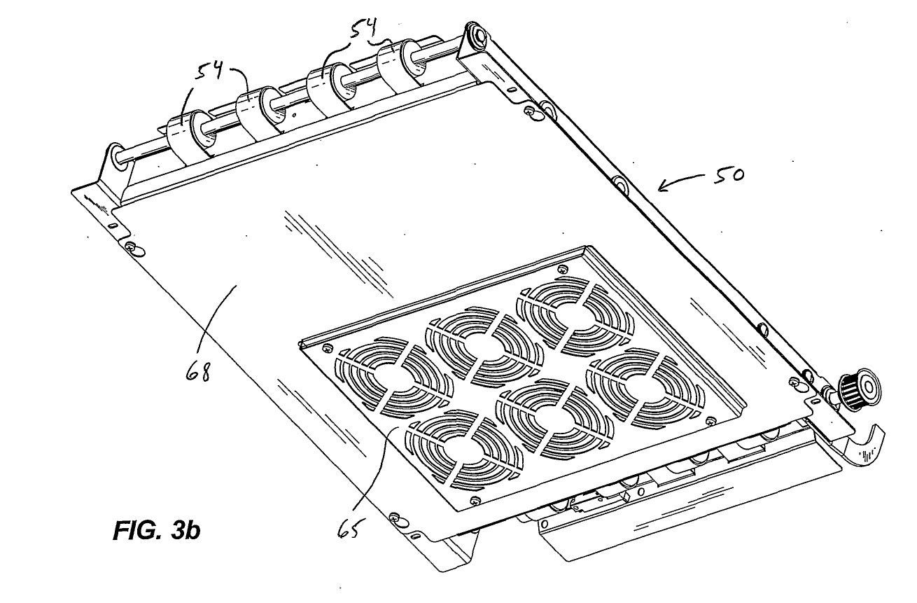

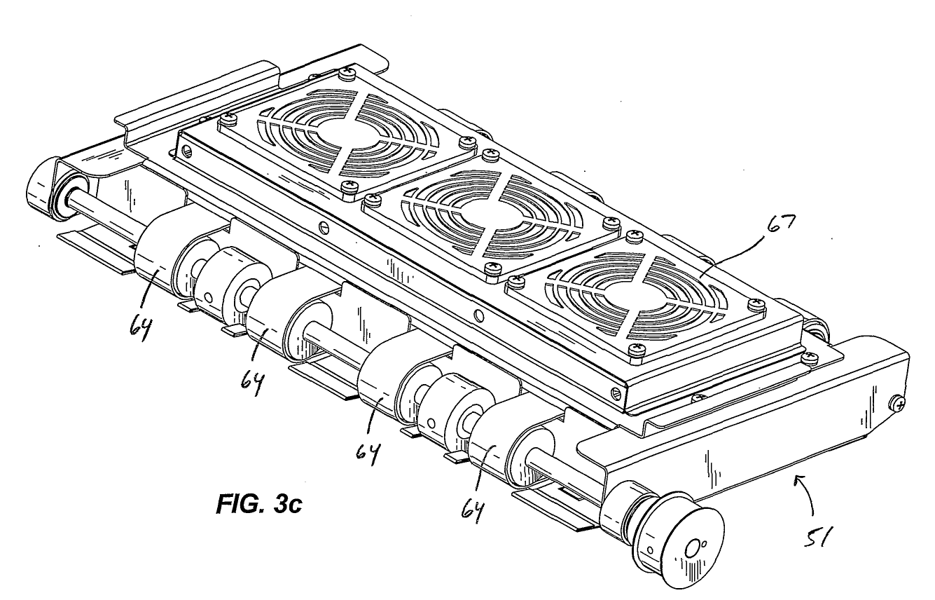

Turning now to FIG. 3a, in one embodiment, the transport assembly 26 includes at least two vacuum-assisted belt conveyors 50, 51 for the feeding path 30 and the removal path 32, respectively. It should be noted that the feeding path 30 as illustrated in this embodiment is at a position relatively lower than the removal path 32. It should be appreciated that the feeding path 30 could alternately be disposed at a position relatively higher than the removal path 32 or otherwise disposed as dictated by the geometry of the machine and sheet source. While each of the vacuum-assisted belt conveyors 50, 51 may be of any appropriate design(s), the illustrated vacuum-assisted belt conveyor 50, or entry conveyor 50, includes a vacuum chamber 52 and a plurality of belts 54 arranged to loop around the vacuum chamber 52. The belts 54 of the entry conveyor 50 are driven by a motor 55 to rotate around the vacuum chamber 52. In order to provide vacuum suction to the sheets 33 as they are conveyed by the entry conveyor 50, the vacuum chamber 52 of the entry conveyor 50 includes a plurality of openings 60 in its deck wall 53 facing the sheet feeding path 30. The openings 60 are disposed generally between the belts 54. The vacuum suction provided by air flow through the openings 60 holds a sheet 33 on the belts 54 so that the sheet 33 is moved forward by the rotating belts 54. The vacuum or air suction may be provided by a fan 61 as shown in FIG. 3a, or by other suitable means for generating a pressure differential.

With reference to FIGS. 3a and 4a-6, the vacuum-assisted belt conveyor 51, or the exit conveyor 51, includes a vacuum chamber 62 having a plurality of openings 60 in its deck wall 63 facing the sheet removal path 32 through which a vacuum suction is drawn. Further, the exit conveyor 51 includes a plurality of belts 64 arranged to loop around the vacuum chamber 62. Like the belts 54 of the entry conveyor 50, the belts 64 of the exit conveyor 51 may be driven by the motor 55. The openings 60 in the vacuum chamber 62 are disposed generally between the belts 64 and face downwardly to hold sheets 33 on the belts 64 as the sheets 33 are carried away from the punch 20. With reference to FIG. 3a, the fan 61 may also be used to provide the vacuum suction to the vacuum chamber 62.

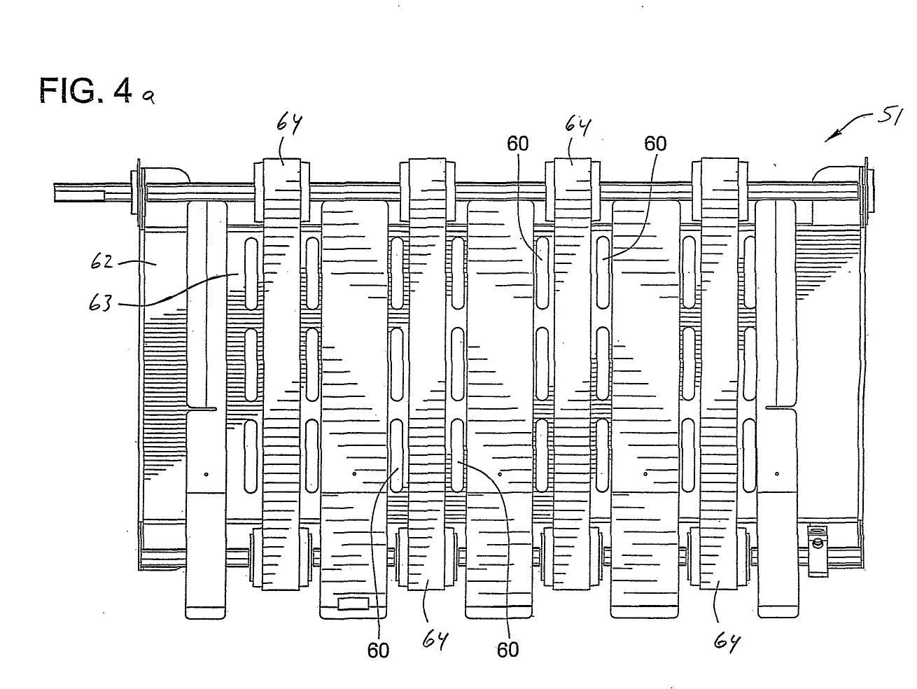

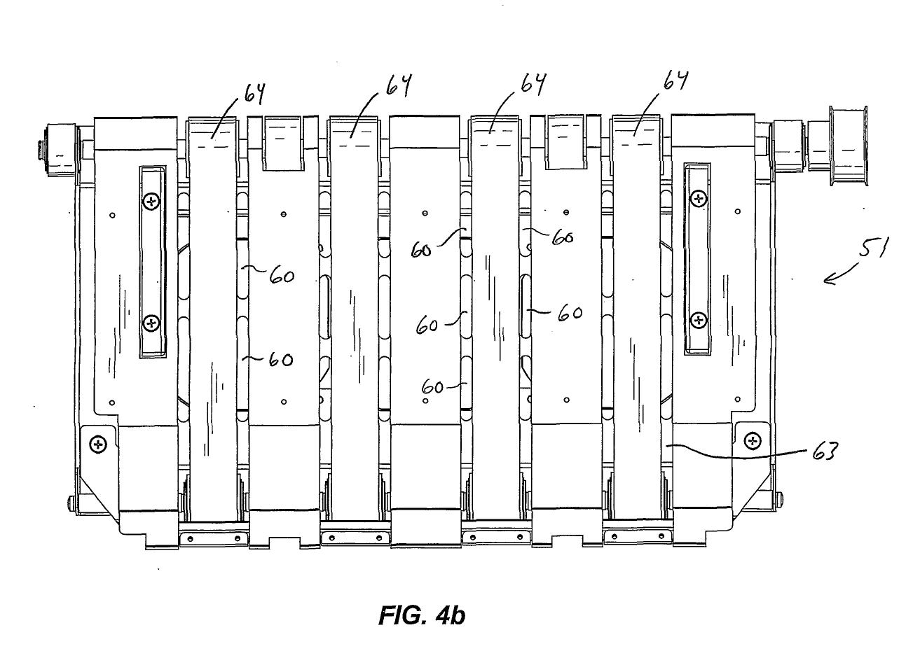

With reference to FIGS. 3b and 3c, rather than utilizing a single fan 61 to provide the vacuum suction for both the vacuum chambers 52, 62, each of the entry and exit conveyors 50, 51 may include separate fan assemblies 65, 67 to provide the vacuum suction for the respective conveyors 50, 51. With reference to FIG. 3b, a back wall 68 seals the vacuum chamber 52, while the fan assembly 65 may be coupled to the back wall 68 to draw the vacuum suction through the openings 60 in the deck wall 53 and through one or more openings (e.g., the exhaust openings in the fan assembly 65) in the back wall 68. Similarly, with reference to FIG. 3c, the fan assembly 67 may be coupled to the vacuum chamber 62 to seal the vacuum chamber 62 and to draw the vacuum suction through the openings 60 in the deck wall 63 (see FIG. 4b).

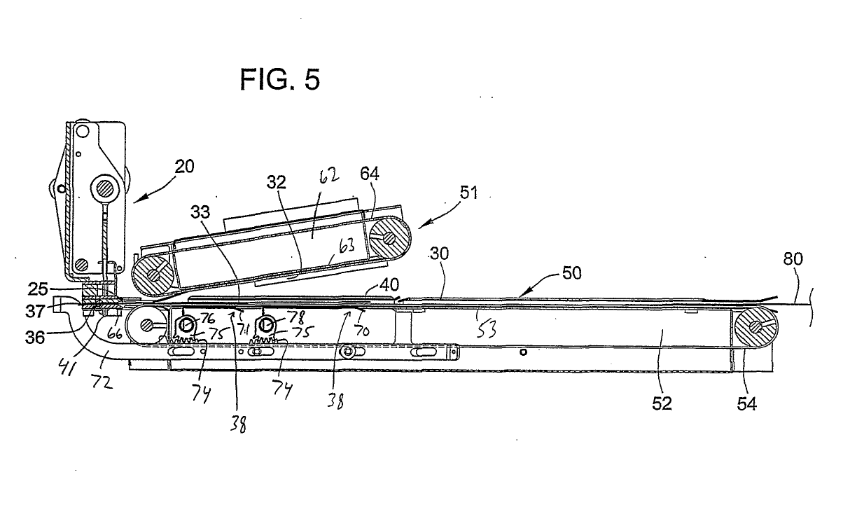

As shown in FIG. 5, a sheet 33 to be punched is carried by the belts 54 of the entry conveyor 50 toward the punch 20. The first edge 36 of the sheet 33, which is the originally leading edge in the feeding direction, enters the throat 25 of the punch 20 and is advanced until it reaches the stop 37, which defines the proper location of the first edge 36 when the sheet 33 is in registration for hole punching. A sensing device (e.g., a photo sensor 66 as illustrated in FIGS. 1, 5, 6, 12, 13, 15, and 16) detects that the first edge 36 of the first sheet 33 has registered in the punch 20, and generates a signal that triggers the actuation of the punch pins 41 of the punch 20. Alternatively, the sensor 66 may be configured to detect the first edge 36 of the first sheet 33, and generate a signal that triggers the actuation of the punch pins 41. In this instance, a time delay may be incorporated between the sensor 66 detecting the first edge 36 of the first sheet 33 and the actuation of the punch pins 41 to allow sufficient time for the first sheet 33 to be received in the throat 25 and registered against the stop 37. Such a time delay may occur as a result of the sensor 66 outputting a delayed signal to a controller 10 (see FIG. 1), or as a result of the controller 10 receiving the signal from the sensor 66 and outputting a delayed actuation signal to the drive mechanism 14 to cause actuation of the punch pins 41.

With reference to FIGS. 5 and 6, in order to disengage the first sheet 33 from the vacuum suction holding the sheet 33 to the feed belts 54, the deflector mechanism 38 is provided. In the illustrated embodiment, the entry conveyor 50 has one or more sets of deflector fingers 70, 71 pivotably mounted therein. The deflector fingers 70, 71 can be pivoted to extend beyond the deck wall 53 of the vacuum chamber 52 through slots in the deck wall 53. The fingers 70, 71 are driven by any appropriate mechanism. In the illustrated embodiment of FIGS. 5 and 6, a gear arrangement imparts reciprocating motion such that the fingers 70, 71 are pivoted to extend through the slots toward the deck wall 63 of the exit conveyer 51 (see FIG. 6) and then retracted back into the entry conveyor 50. Specifically, the sliding motion of input link 72 is transmitted to a slidably mounted rack 74 disposed to engage and pivot pinion gears 75. The pivoting of pinion gears 75 causes rotation of shafts 76, 78 that are connected to the fingers 70, 71, which, in turn, causes the deflector fingers 70, 71 to pivot or rotate. The input link 72 may be actuated by any of a number of different mechanisms or devices, such as, for example, a camshaft or a solenoid.

When the sheet 33 is registered in the punch 20 and is being punched, the deflector fingers 70, 71 are actuated to push the second edge 40 of the sheet 33 away from the belts 54 of the entry conveyor 50 and toward the belts 64 of the exit conveyor 51, while the first edge 36 of the sheet 33 is still in the punch 20. When the sheet 33 is pushed to a position sufficiently close to the exit conveyor 51, the vacuum suction provided by the openings 60 of the vacuum chamber 62 of the exit conveyor 51 pulls the sheet 33 into contact with the rotating belts 64 of the exit conveyor 51. As a result, the sheet 33 is now on the removal path 32 and is carried by the rotating belts 64 out of and away from the punch 20. The operation of the deflector fingers 70, 71 is coordinated with the activation of the punch 20 such that the sheet 33 is captured and carried away by the exit conveyor 51 after the completion of the hole punching operation, i.e., when the punch pins 41 of the punch 20 have cleared the punched sheet 33.

After the deflector fingers 70, 71 are returned to their retracted positions so that they do not extend beyond the rotating belts 54, the next sheet 80 (see FIG. 5) can be advanced by the entry conveyor 50 to the punch 20 without interference. This allows the two sheets 33, 80 to coexist within the transport assembly 26 without coming into contact with each other. As the second sheet 80 is advanced into the punch 20, the punch 20 completes the punching operation and opens as the first sheet 33 is removed from the punch 20 by the exit conveyor 51 and as the entry conveyor 50 simultaneously feeds the second sheet 80 to the punch 20. Because multiple sheets (e.g., sheets 33 and 80) can coexist within the transport assembly 26 at any given time, the punch 20 may be operated at a slower speed, thereby consuming less power compared to conventional arrangements.

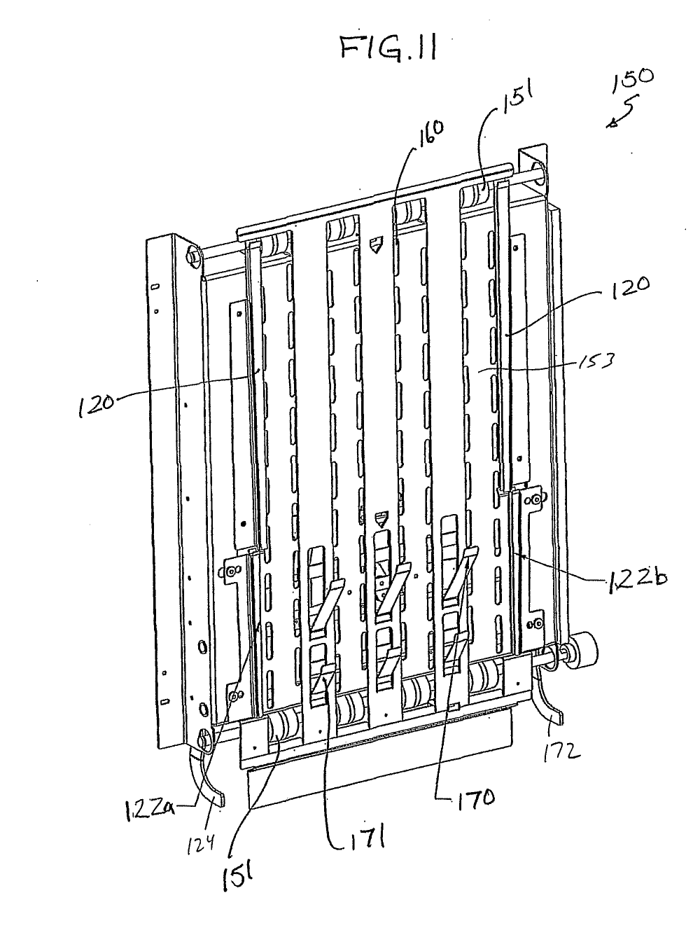

With reference to FIG. 11, a second embodiment of the entry conveyor 150 may include stationary edge guides 120 and moveable edge guides 122a, 122b for guiding sheets 33 as they pass along the entry conveyor 150. Otherwise, the entry conveyor 150 may be substantially similar to the entry conveyor 50, such that like structure may be identified with like reference numerals, adding “100.” The entry conveyor 150 of FIGS. 11-13 may be used in place of the entry conveyor 50 of FIGS. 3a, 3b, 5, and 6, and the entry conveyor 150 will be described herein with reference to the exit conveyor 51 and the punch 20 of FIGS. 2a, 3a, and 3c-6.

With reference to FIG. 11, the edge guides 120, 122a, 122b present a surface that is generally disposed along the side of the passing sheet opposite the vacuum chamber 152. As such, the guides 120, 122a, 122b may present an “L” shaped, “C” shaped, “V” shaped, “U” shaped or other appropriate cross-section, or merely an angled surface. While the belts have been removed to more clearly illustrate the components of the entry conveyor 150 in the fragmentary illustrations in FIGS. 11-13, it will be appreciated that the belts would be disposed in substantially the same position as shown in FIG. 3a, i.e., about rollers 151 and vacuum chamber 152 such that sheets 33 passing with the belts would be retained by a vacuum suction drawn through vacuum openings 160. In this embodiment, stationary edge guides 120 are provided along the entry portion of the entry conveyor 150, while moveable edge guides 122a, 122b are provided along the portion of the entry conveyor 150 disposed adjacent the opposite end of the entry conveyor 150 or proximate the punch 20.

As the leading edge of the sheet 33 approaches the punch 20 and its forward motion is arrested by the stop 37, the moveable edge guides 122a, 122b move outward to allow the deflector fingers 170, 171 to deflect the sheet 33 to the exit conveyor 51. In a preferred embodiment of the invention, the moveable edge guides 122a, 122b maintain their position holding the sheet 33 until such time as the sheet 33 is registered in the punch 20 and the punch pins 41 enter the sheet 33. The moveable edge guides 122a, 122b are then moved out of contact with the sheet 33 to allow transfer of the sheet 33 to the exit conveyor 51.

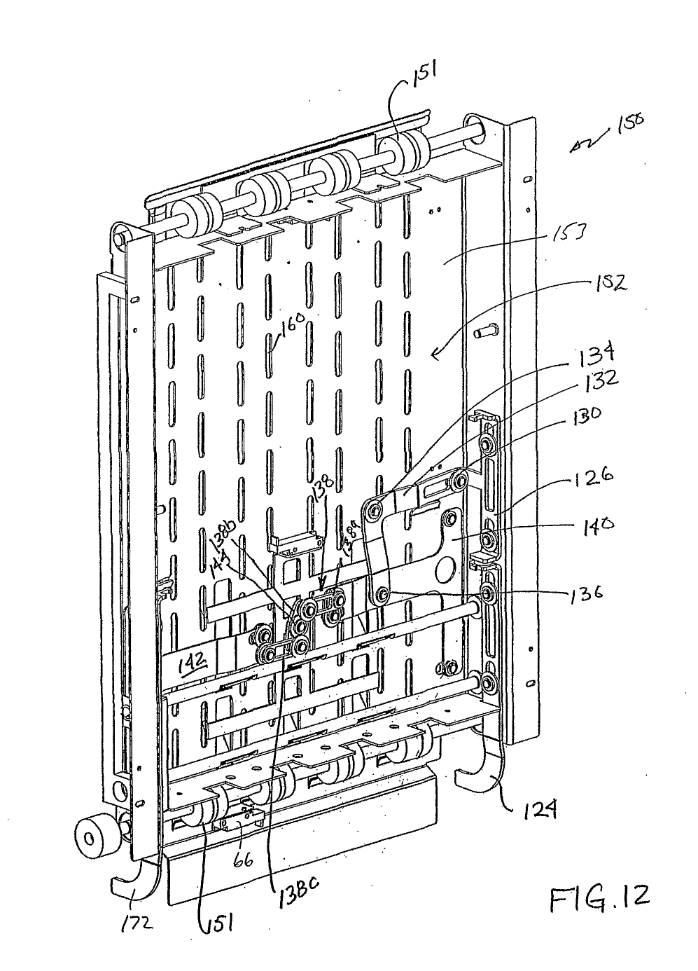

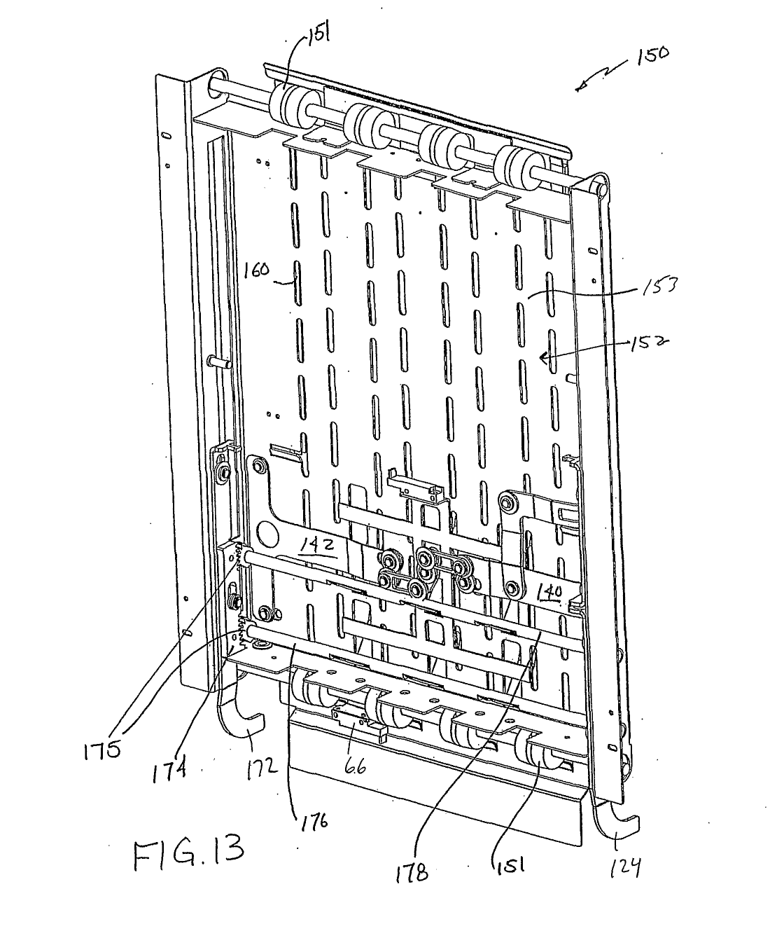

While this movement of the moveable edge guides 122a, 122b may be accomplished by any appropriate method, in the illustrated embodiment, a slidably disposed cam input link 124 provides a linear motion to slidably disposed input link 126 (see FIGS. 12 and 13). This linear motion is transmitted at pivot coupling 130 to an L-shaped link 132, which pivots at its apex 134 to transmit motion to a pivot coupling 136 to a Watts linkage 138. More specifically, the pivot coupling 136 is coupled to a first bracket 140 that is secured to one of the moveable edge guides 122a and slidably disposed relative to the deck wall 153 of the vacuum chamber 152 such that the coupled edge guide 122a moves outward. The movement of the link 132 is further transmitted to the opposite edge guide 122b via the Watts linkage 138 coupled to a second bracket 142 similarly secured to edge guide 122b and slidably coupled to the deck wall 153. The Watts linkage 138 includes links 138a, 138b, 138c, link 138b being pivotably coupled to the deck wall 153 at pivot point 144. In this way, a sliding motion of cam input link 124 is transmitted to sliding link 126, to pivoting link 132, to sliding bracket 140 secured to edge guide 122a, and, via Watts linkage 138, to sliding bracket 142 secured to edge guide 122b, to move the moveable edge guides 122a, 122b apart to release a sheet 33 passing through the entry conveyor 150.

It should be appreciated that the edge guides 120, 122a, 122b minimize the effect of excessive sheet curl, and assist in proper positioning of the sheet 33 within the punch 20. Moreover, the edge guides 120, 120a, 122b reduce the possibility that the sheet 33 entering the punch 20 will become prematurely engaged by the exit conveyor 51.

FIG. 13 also illustrates an arrangement for pivoting the deflector fingers 170, 171. The arrangement for pivoting the deflector fingers 170, 171 is substantially similar to the arrangement illustrated in FIGS. 5 and 6, with like components having like reference numerals, adding “100.” The sliding motion of cam input link 172 is transmitted to a slidably mounted rack 174 disposed to engage and pivot pinion gears 175. The pivoting of pinion gears 175 is further transmitted to the deflector fingers 170, 171 by the rotation of shafts 176, 178. Sliding motion of the cam input links 124, 172 may substantially simultaneously or sequentially occur, if so desired, to move apart the moveable edge guides 122a, 122b as the deflector fingers 170, 171 are pivoted outward to deflect a sheet 33 from the entry conveyor 150 to the exit conveyor 51. While the movement of the moveable edge guides 122a, 122b and the deflector fingers 170, 171 have been described with regard to certain mechanisms, those of skill in the art will appreciate that alternate mechanisms for moving these elements are well within the purview of the invention.

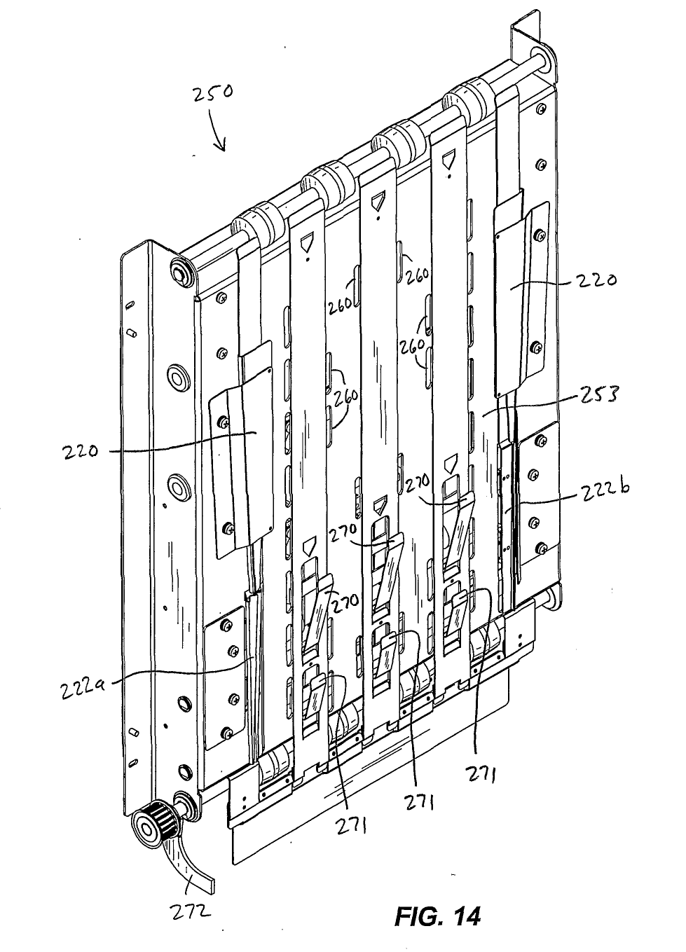

With reference to FIGS. 14-16, yet another embodiment of an entry conveyor 250 is shown. Specifically, the entry conveyor 250 includes stationary edge guides 220 and moveable edge guides 222a, 222b for guiding sheets 33 as they pass along the entry conveyor 250. Otherwise, the entry conveyor 250 may be substantially similar to the entry conveyor 50, such that like structure may be identified with like reference numerals, adding “200.” The entry conveyor 250 of FIGS. 14-16 may be used in place of the entry conveyor 50 of FIGS. 3a, 3b, 5, and 6 or the entry conveyor 150 of FIGS. 11-13.

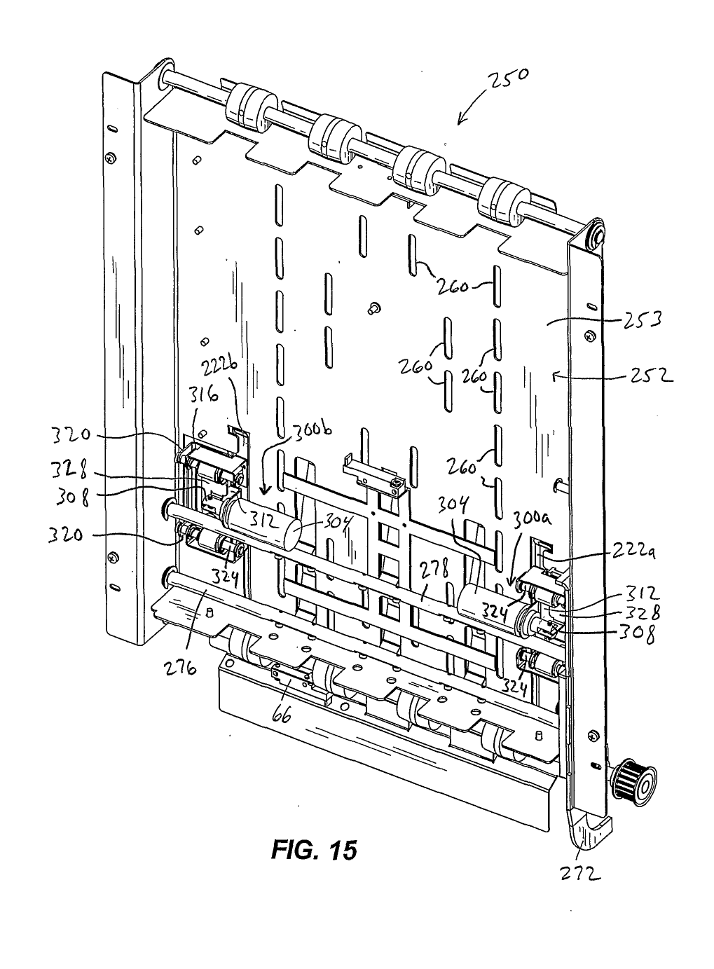

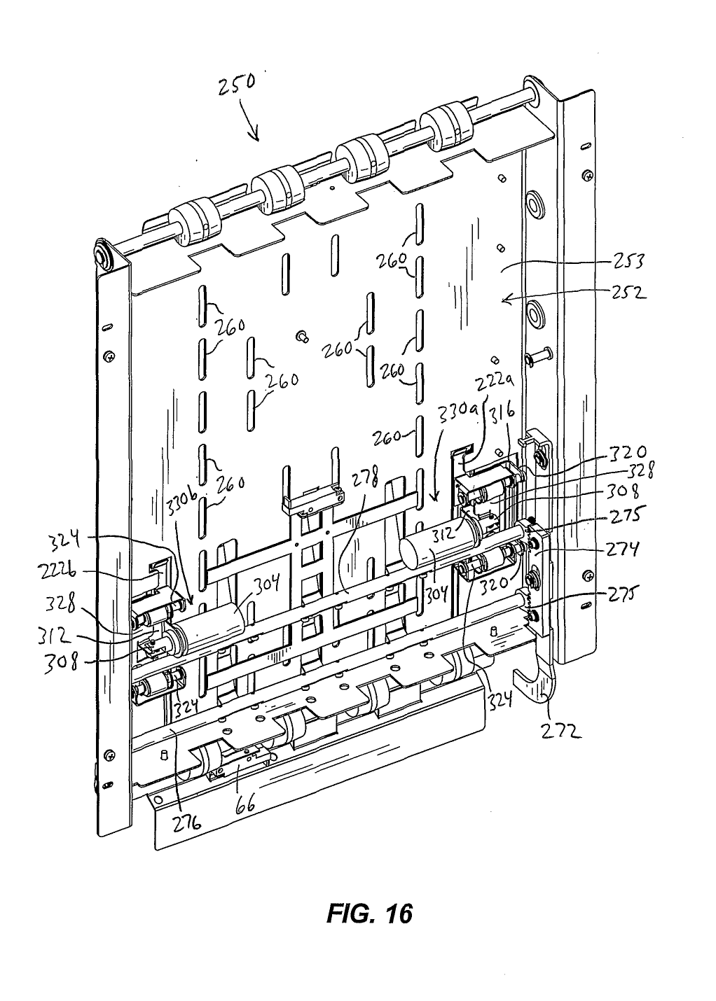

With reference to FIGS. 15 and 16, the moveable edge guides 222a, 222b are moved between their innermost and outermost positions by respective solenoids 300a, 300b. Each of the solenoids 300a, 300b includes a body 304 and a plunger 308 movable with respect to the body 304. The body 304 is coupled to the deck wall 253 of the entry conveyor 250 by a bracket 312. Another bracket 316 that is coupled to the deck wall 253 includes two pairs of ears 320, each pair of ears 320 supporting a shaft 324. An edge guide bracket 328 is slidably coupled to the shafts 324 and coupled to the plunger 308 of the respective solenoid 300a, 300b. The edge guides 222a, 222b are coupled to the respective edge guide brackets 328, and are movable in response to movement of the edge guide brackets 328. Springs may be utilized to bias the edge guides 222a, 222b, either directly or indirectly through the edge guide brackets 328 or through the plunger 308, toward their respective innermost or outermost positions.

In the illustrated construction of the entry conveyor 250, actuation of the solenoids 300a, 300b causes the edge guides 222a, 222b to move inwardly. During operation of the entry conveyor 250, the solenoids 300a, 300b may be either separately or simultaneously actuated to cause movement of either one of the edge guides 222a, 222b or both of the edge guides 222a, 222b, respectively. Upon actuation of the solenoid 300a, for example, the plunger 308 retracts into the body 304, causing the edge guide bracket 328 to slide along the shafts 324 relative to the brackets 312, 316 fixed to the deck wall 253. Because it is coupled to the edge guide bracket 328, the edge guide 222a moves with the edge guide bracket 328. The operation of the edge guide 222b is substantially the same as that of the edge guide 222a.

With reference to FIGS. 14 and 16, the entry conveyor 250 utilizes a similar gear arrangement, including the input link 272, the rack 274, and the pinion gears 275 mounted on respective shafts 276, 278 with which to actuate the deflector fingers 270, 271 between their extended and retracted positions as the entry conveyors 50, 150. As such, reference is made to the text above relating to the operation of the deflector fingers 70, 71, 170, 171 for a description of the operation of the deflector fingers 270, 271.

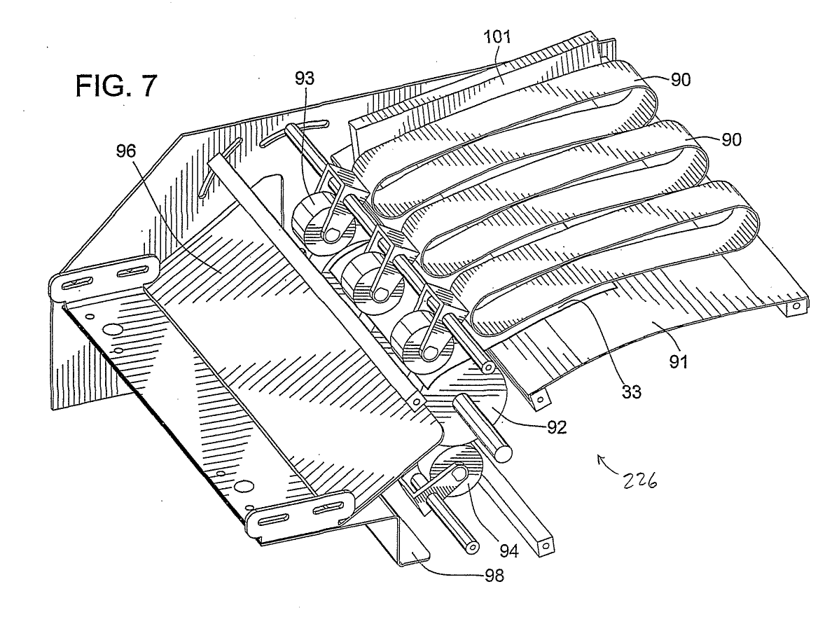

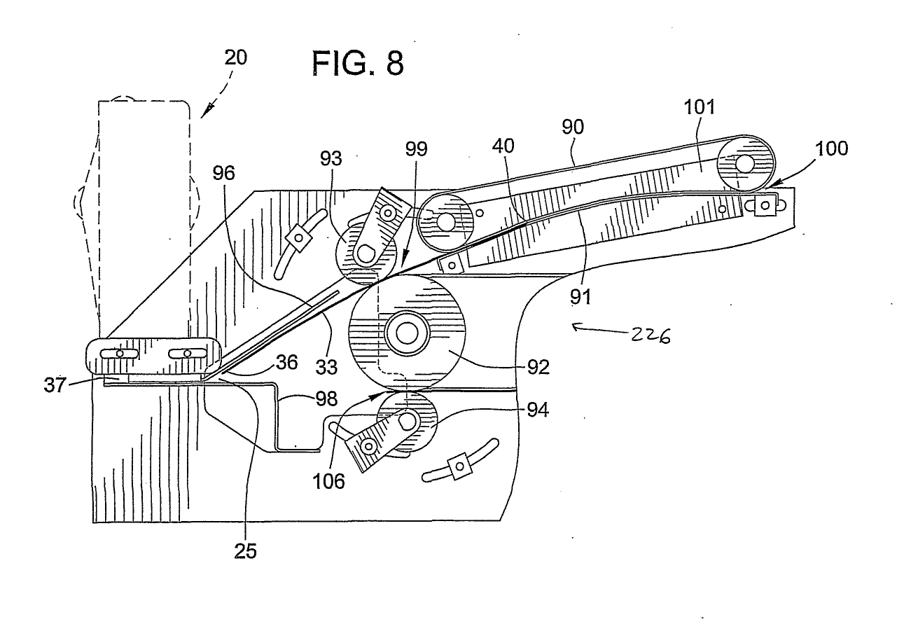

With reference to FIGS. 7-10, an alternative embodiment of a transport assembly 226 is shown. Specifically, the transport assembly 226 utilizes a rotating surface to both advance the sheet 33 into the punch 20 and to deflect the originally trailing edge 40 of the sheet 33 onto a sheet removal path. As shown in FIGS. 7 and 8, a low friction belt 90 acting on a curved surface of a sheet input support 91, or other appropriate mechanism, operates to supply sheets 33 to the punch 20. The transport assembly 226 includes a centrally disposed rotating element with a rotating surface that forms an input nip 99 and an exit nip 106 with two cooperating surfaces, such that a sheet 33 to be punched passes through the input nip 99 toward the punch 20, and the punched sheet is passed through the exit nip 106 and removed from the punch 20. In the particular assembly 226 illustrated in FIGS. 7 and 8, the rotating element is in the form of a roller 92, which cooperates with one or more input idle rollers 93 and one or more output idle rollers 94 to form the input nip 99 and output nip 106, respectively. It will be appreciated by those skilled in the art, however, that the rotating surface and input and exit nips 99, 106 may be provided using other suitable structures. The transport assembly 226 may also include an input sheet guide 96 for guiding the sheet 33 into the throat 25 of the punch 20, and a deflection guide 98 that operates to control the bending of the sheet 33 to facilitate its deflection from the input path to the removal path as described in greater detail below. For clarity of illustration, the punch pins and the drive mechanism of the punch 20 are not shown in detail.

With reference to FIG. 8, a sheet 33 to be fed to the punch 20 enters the input gap 100 between the rotating belt 90 and the support surface 91, and is advanced by the belt 90 along the curved support surface 91 towards the input nip 99. The sheet support surface 91 preferably includes a side edge guide 101 for aligning the side edge of the sheet 33, and the belt 90 is preferably slightly angled towards the side edge guide 101 such that the sheet 33 being forwarded by the belt 90 is also driven towards the side edge guide 101 until its side edge makes contact with the side edge guide 101. The columnar strength of the sheet 33 when it is forced to curve on the support surface 91 generally provides sufficient strength to the sheet 33 so that it slips on the belt 90 and registers along the side edge guide 101.

Once the first or leading edge 36 of the sheet 33 reaches the input nip 99 between the driven roller 92 and the input idle rollers 93, the sheet 33 passes through the input nip 99 and is moved forward further by the rotating driven roller 92, and guided by the input sheet guide 96 into the punch throat 25. The input sheet guide 96 is preferably set at an angle with respect to the punch throat 25 such that a bend is induced in the sheet 33 as it enters the throat 25. The first edge 36 of the sheet 33, which is the leading edge in the feeding direction, continues to move until it contacts the stop 37 in the punch 20 and is thus in registration for punching. Once the first edge 36 contacts the stop 37, the punch 20 can be activated to punch holes in the sheet 33 along the first edge 36. The triggering signal for activating the punch 20 may be provided by the photo sensor 66 as shown in FIG. 1 or any other appropriate mechanism or means.

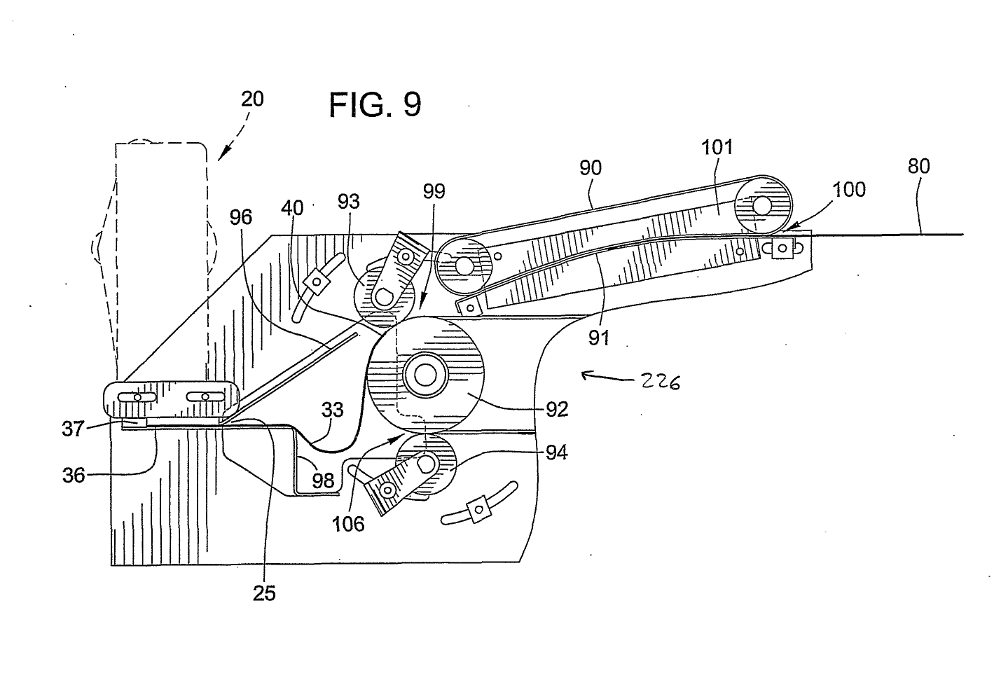

With reference to FIG. 9, when the forward movement of the leading edge 36 of the sheet 33 is arrested as it engages the stop 37 in the punch 20, the continued movement of the body of the sheet 33 through the nip 99 between the driven roller 92 and the input idle rollers 93 causes a bend to develop in the sheet 33. The shape of the bend is controlled by the deflection guide 98. The driven roller 92 continues to move the sheet 33 until its second edge 40, which is the trailing edge in the feeding direction, passes the input nip 99. The bending of the sheet 33 as its trailing edge 40 leaves the input nip 99 is generally shown in FIG. 9. Due to the bending and the stiffness of the sheet 33, a frictional force exists between the second or trailing edge 40 of the sheet and the surface of the high-friction driven roller 92. This frictional force between the trailing edge 40 of the sheet 33 and the driven roller 92 causes the trailing edge 40 to continue to be carried by the roller 92 with little slippage after it leaves the input nip 99. It will be appreciated that the rotating surface, or driven roller 92 in the illustrated embodiment, may alternately or additionally include structure for affirmatively engaging the second edge 40 of the sheet 33, such as, by way of example only, a plurality of barbs or other protrusions.

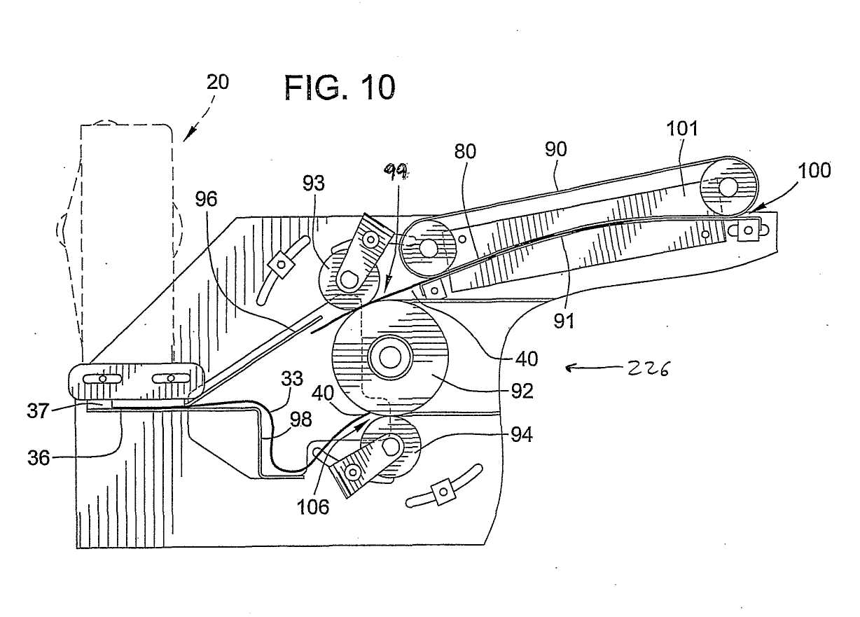

As the second edge 40 of the sheet 33 moves closer to the exit nip 106 formed by the driven roller 92 and the output idle rollers 96, the continued movement of the body of the sheet 33 causes the second or trailing edge 40 of the sheet 33 to eventually flip over as shown in FIG. 10. The stiffness of the sheet 33 constrained by the geometry of the deflection plate 98 and the driven roller 92 causes the second edge 40 to snap into the exit nip 106. The second edge 40 of the sheet 33, which now has become the leading edge along the sheet removal path, is then driven through the exit nip 106, and, as a result, the sheet 33 is removed from the punch 20. The rotational speed of the driven roller 92 and the timing of the activation of the punch 20 are such that the punching operation is completed by the time the first edge 36 of the sheet 33 is pulled away from the stop 37 in the punch 20.

As shown in FIG. 10, after the originally trailing edge 40 of the sheet 33 has left the input nip 99, the next sheet 80 may be forwarded through the input nip 99 and advanced toward the punch 20. In this way, once the punched sheet 33 is pulled away from the punch 20 and its originally leading edge 36, which is now the trailing edge, clears the throat 25 of the punch 20, the leading edge of the next sheet 80 is ready to enter the punch 20. In this way, the rotating surface, or driver roller 92 in this embodiment, either alone or in combination with the deflection plate 98 acts as deflector to deflect the sheet 33 to the removal path. This efficient sheet feeding and removal arrangement allows the punch 20 to handle sheets 33 fed to it at a high rate, without the need to decelerate incoming sheets 80 to avoid collisions.

It should be appreciated that although the first nip 99 and the second nip 106 are shown as created by a centrally disposed driver roller 92 and the idler rollers 93 and 94, respectively, these nips 99, 106 may be created by alternative components, so long as the same ultimate direction reversal of the sheet 33 is achieved. By way of example only, the central driven roller 92 may be replaced by a rotating surface that is part of a driven belt arrangement, so long as substantially continuous motion is imparted to the rotating surface to carry the second end 40 of the sheet 33. By way of further example, either or both of the rollers 93 and 94 may be replaced with cooperating surfaces that are part of one or more belt systems, with or without the central roller 92 being driven by the belt systems. Alternatively, all such elements may be driven in synchronization. As yet another example, the idler rollers 93 and 94 may be replaced by fixed members that each provides a low-friction surface (e.g., using a material of low friction such as Teflon®) to cooperate with the centrally disposed rotating surface to form the input nip 99 or the exit nip 106.

It should be further appreciated by those of skill in the art that the arrangements described above for punching in combination with a change or reversal in the direction of sheet flow may likewise be utilized without a punch to provide a change in the sheet flow direction in a sheet processing system.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiments can be modified in arrangement and detail, and combined without departing from the spirit of the invention. Therefore, the invention as described herein contemplates all such embodiments as may come within the scope of the following claims and equivalents thereof.

What is claimed is:

1. A punch assembly for punching a plurality of consecutive sheets each having a first edge and a second edge generally opposite the first edge, the punch assembly comprising:
a punch;
a transport assembly having
a feeding path for feeding the first edge of a sheet in a feeding direction relative to the punch for punching thereof;
a removal path different from the feeding path for removing the sheet from the punch in a removal direction generally opposite to the feeding direction relative to the punch such that the second edge becomes a leading edge; and
a deflector operable to deflect the second edge of the sheet from the feeding path to the removal path when the first edge of the sheet is registered in the punch for punching.

2. The punch assembly of claim 1, wherein the transport assembly includes
an input surface along the feeding path;
an output surface along the removal path; and
a centrally disposed rotary element having a rotating surface forming an input nip with the input surface along the feeding path and an exit nip with the output surface along the removal path, wherein the deflector includes the rotating surface disposed to deflect the second edge of the sheet from the input nip to the exit nip when the first edge of the sheet is registered in the punch for punching.

3. The punch assembly of claim 2, wherein the rotating surface causes the sheet to bend to cause the second edge to be deflected from the input nip to the exit nip.

4. The punch assembly of claim 2, wherein the centrally disposed rotary element is a driven roller, and wherein the transport assembly includes a first idler roller having the input surface and a second idler roller having the output surface.

5. The punch assembly of claim 2, wherein the deflector includes a deflection guide disposed for controlling bending of the sheet caused by the rotating surface.

6. The punch assembly of claim 1, wherein the transport assembly includes a first vacuum-assisted belt conveyor defining at least a portion of the feeding path, and a second vacuum-assisted belt conveyor defining at least a portion of the removal path.

7. The punch assembly of claim 6, wherein each of the first and second vacuum-assisted belt conveyors includes a vacuum chamber and a plurality of rotating belts looped around the vacuum chamber, and wherein the vacuum chambers in each of the first and second vacuum-assisted belt conveyors include openings disposed between the belts to provide vacuum suction for holding sheets onto the belts.

8. The punch assembly of claim 6, wherein the transport assembly includes a deflector operable to deflect the second edge of the sheet from the feeding path to the removal path when the first edge of the sheet is registered in the punch for punching, and wherein the deflector includes at least one deflecting finger extendable from the first vacuum-assisted belt conveyor to deflect the sheet from the first vacuum-assisted belt conveyor to the second vacuum-assisted belt conveyor.

9. The punch assembly of claim 1, wherein the punch includes a sensor for detecting the first edge of the sheet and generating a trigger signal for triggering activation of the punch to punch holes in the sheet.

10. The punch assembly of claim 1, wherein the punch includes a stop for engaging the first edge of the sheet to register the sheet for punching.

11. The punch assembly of claim 1, further comprising at least one of a stationary edge guide and a moveable edge guide disposed substantially adjacent the feeding path.

12. The punch assembly of claim 1, wherein the sheet is a first sheet, and wherein a second sheet is transported along the feeding path while the first sheet is transported along the removal path.

13. A document processing device for processing sheets, each sheet having a first edge and a second edge generally opposite the first edge, the device comprising:
a sheet source for generating a stream of consecutive sheets;
a punch; and
a transport assembly for feeding the consecutive sheets from the sheet source to the punch for punching and moving punched sheets from the punch to a subsequent processing stage of the document processing device, the transport assembly having a feeding path for feeding the consecutive sheets in a feeding direction relative to the punch with the first edge as a first leading edge, a removal path different from the feeding path for removing the sheets from the punch in a removal direction generally opposite to the feeding direction relative to the punch with the second edge becoming a second leading edge, and a deflector operable to deflect the sheet from the feeding path to the removal path when the first edge of the sheet is registered in the punch for punching.

14. The document processing device of claim 13, wherein the transport assembly includes
an input surface along the feeding path;
an output surface along the removal path; and
a centrally disposed rotary element having a rotating surface forming an input nip with the input surface along the feeding path and an exit nip with the output surface along the removal path, wherein the deflector includes the rotating surface disposed to deflect the second edge of the sheet from the input nip to the exit nip when the first edge of the sheet is registered in the punch for punching.

15. The document processing device of claim 14, wherein the rotating surface causes the sheet to bend to cause the second edge to be deflected from the input nip to the exit nip.

16. The document processing device of claim 14, wherein the centrally disposed rotary element is a driven roller, and wherein the transport assembly includes a first idler roller at least partially defining the input surface and a second idler roller at least partially defining the output surface.

17. The document processing device of claim 14, wherein the deflector includes a deflection guide disposed for controlling bending of the sheet caused by the rotating surface.

18. The document processing device of claim 13, wherein the transport assembly includes a first vacuum-assisted belt conveyor defining at least a portion of the feeding path, and a second vacuum-assisted belt conveyor defining at least a portion of the removal path.

19. The document processing device of claim 18, wherein each of the first and second vacuum-assisted belt conveyors includes a vacuum chamber and a plurality of rotating belts looped around the vacuum chamber, and wherein the vacuum chambers in each of the first and second vacuum-assisted belt conveyors include openings disposed between the belts to provide vacuum suction for holding sheets onto the belts.

20. The document processing device of claim 18, wherein the deflector includes at least one deflecting finger extendable from the first vacuum-assisted belt conveyor to deflect the sheet from the first vacuum-assisted belt conveyor to the second vacuum-assisted belt conveyor.

21. The document processing device of claim 13, wherein the punch includes a sensor for detecting the first edge of the sheet and generating a trigger signal for triggering activation of the punch to punch holes in the sheet.

22. The document processing device of claim 13, wherein the punch includes a stop for engaging the first edge of the sheet to register the sheet for punching.

23. The document processing device of claim 13, further comprising at least one of a stationary edge guide and a moveable edge guide disposed substantially adjacent the feeding path.

24. The document processing device of claim 13, wherein the consecutive sheets includes a first sheet and a second sheet following the first sheet, wherein the second sheet is transported along the feeding path while the first sheet is transported along the removal path.

25. A method of punching a sheet using a punch, the method comprising:
providing a mechanical transport assembly having a feeding path and a removal path;
advancing the sheet in a feeding direction along the feeding path to the punch until a first edge of the sheet is registered in the punch;
activating the punch to punch the sheet;
deflecting a second edge of the sheet generally opposite to the first edge onto the removal path while the first edge of the sheet is registered in the punch; and
carrying the sheet away from the punch in a removal direction along the removal path after the sheet is punched, the removal direction being generally opposite to the feeding direction relative to the punch.

26. The method of claim 25, further comprising detecting the first edge of the sheet before activating the punch.

27. The method of claim 25, wherein the sheet is a first sheet, further comprising advancing a second sheet along the feeding path while the first sheet is carried along the removal path.

28. A punch configured for punching a plurality of consecutive sheets each having a first edge and a second edge generally opposite the first edge, the punch comprising:
a throat configured to receive the first edge of a sheet;
a plurality of punch pins extending along the throat, each of the punch pins defining a punching axis and movable between a first position substantially outside the throat and a second position within the throat; and
a drive mechanism drivably coupled to the plurality of punch pins to actuate the punch pins between the first and second positions;
wherein each of the punch pins includes a cross-sectional shape in a plane substantially perpendicular to the punching axis and passing through the punch pin, the cross-sectional shape having opposed, at least partially arcuate longitudinal edges.
